(19) United States
(12) Patent Application Publication
(10) Pub. No.: US 2017/0142668 A1
(43) Pub. Date: May 18, 2017

(54) USER TERMINAL, RADIO BASE STATION, RADIO COMMUNICATION SYSTEM AND RADIO COMMUNICATION METHOD

(71) Applicant: NTT DOCOMO, INC., Tokyo (JP)

(72) Inventors: Kazuki Takeda, Tokyo (JP); Hiroki Harada, Tokyo (JP); Tooru Uchino, Tokyo (JP); Satoshi Nagata, Tokyo (JP)

(73) Assignee: NTT DOCOMO, INC., Tokyo (JP)

(21) Appl. No.: 15/323,132

(22) PCT Filed: May 27, 2015
(86) PCT No.: PCT/JP2015/065160

§ 371 Date: Dec. 30, 2016

(30) Foreign Application Priority Data
Jun. 30, 2014 (JP) 2014-134751

(51) Int. Cl. H04W 52/36; H04W 72/04

(52) U.S. Cl. CPC H04W 52/365; H04W 52/367; H04W 72/0446

(57) ABSTRACT

The present invention is designed so that user terminal operations are carried out adequately when guaranteed transmission power is configured in dual connectivity. A user terminal communicates with a plurality of cell groups, where each cell group is comprised of one or more cells that use different frequencies, and has a receiving section that receives the guaranteed transmission power value of each cell and active/non-active information of the cells in the cell groups, and a power control section that controls the guaranteed transmission power values of the cell groups by using the number of cells in the active state and the guaranteed transmission power value of each cell.

### TECHNICAL FIELD

The present invention relates to a user terminal, a radio base station, a radio communication system and a radio communication method in a next-generation mobile communication system.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1).

In LTE, as multiple access schemes, a scheme that is based on OFDMA (Orthogonal Frequency Division Multiple Access) is used in downlink channels (downlink), and a scheme that is based on SC-FDMA (Single Carrier Frequency Division Multiple Access) is used in uplink channels (uplink).

Successor systems of LTE—referred to as, for example, “LTE-advanced” or “LTE enhancement”—have been under study for the purpose of achieving further broadbandization and increased speed beyond LTE, and the specifications thereof have been drafted as LTE Rel. 10/11.

Also, the system band of LTE Rel. 10/11 includes at least one component carrier (CC), where the LTE system band constitutes one unit. Such bundling of a plurality of CCs into a wide band is referred to as “carrier aggregation” (CA).

In LTE Rel. 12, which is a more advanced successor system of LTE, various scenarios to use a plurality of cells in different frequency bands (carriers) are under study. When the radio base stations to form a plurality of cells are substantially the same, the above-described carrier aggregation is applicable. On the other hand, when the radio base stations to form a plurality of cells are completely different, dual connectivity (DC) may be employed.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

### SUMMARY OF INVENTION

### Technical Problem

Dual connectivity introduces the concept of “guaranteed transmission power,” provided per radio base station or per cell group. Also, in dual connectivity, carrier aggregation can be applied per radio base station or per cell group. In carrier aggregation, it is possible to control activation/deactivation within a cell group, independently and dynamically between cell groups, by means of MAC signaling or by using a timer that is managed by a user terminal or a radio base station. Meanwhile, the transmission power of a user terminal increases with the number of cells to be activated. Consequently, it is likely that the transmission power per cell group which a radio base station wants to guarantee varies depending on the number of cells to be activated. However, if RRC signaling to indicate guaranteed transmission power is sent with the same frequency as the activation and deactivation control executed in the MAC layer, there is a threat that the overhead and delays increase, and lead to a deterioration of throughput.

The present invention has been made in view of the above, and it is therefore an object of the present invention to provide a user terminal, a radio base station, radio communication system and a radio communication method that enable adequate user terminal operations when guaranteed transmission power is configured in dual connectivity.

### Solution to Problem

The user terminal of the present invention provides a user terminal that communicates with a plurality of cell groups, where each cell group is comprised of one or more cells that use different frequencies, and that has a receiving section that receives the guaranteed transmission power value of each cell and active/non-active information of the cells in the cell groups, and a power control section that controls the guaranteed transmission power values of the cell groups by using the number of cells in the active state and the guaranteed transmission power value of each cell.

### Advantageous Effects of Invention

According to the present invention, adequate user terminal operations are enabled when guaranteed transmission power is configured in dual connectivity.

### BRIEF DESCRIPTION OF DRAWINGS

FIG. 1 provide diagrams to show communication between radio base stations and a user terminal in carrier aggregation and dual connectivity;

FIG. 2 provide diagrams to show carrier aggregation control and transmission power control;

FIG. 3 provide diagrams to explain transmission power control in dual connectivity;

FIG. 4 provide diagrams to explain transmission power control in dual connectivity;

FIG. 5 provide diagrams to explain transmission power control in dual connectivity;

FIG. 6 is a diagram to explain non-guaranteed power;

FIG. 7 provide diagrams to explain activation or deactivation of cells in dual connectivity;

FIG. 8 is a diagram to explain the table according to a first example;

FIG. 9 provide diagrams to explain a method according to the first example, in which a user terminal configures guaranteed power depending on the number of cells in the active state;

FIG. 10 is a diagram to explain the table according to a second example;

FIG. 11 provide diagrams to explain a method according to the second example, in which a user terminal configures guaranteed power depending on the number of cells in the active state;

FIG. 12 provide diagrams to explain a case where an area of a secondary base station's guaranteed transmission power P_{SeNB} is present in an area beyond guaranteed transmission power P_{MeNB} and a case where a non-guaranteed power area is present, according to a third example;

FIG. 13 is a diagram to explain a method according to the third example, in which a user terminal reports PHRs to radio base stations;

FIG. 14 is a diagram to show an example of a schematic structure of a radio communication system according to the present embodiment;

FIG. 15 is a diagram to show an example of an overall structure of a radio base station according to the present embodiment;

FIG. 16 is a diagram to show an example of a functional structure of a radio base station according to the present embodiment;

FIG. 17 is a diagram to show an example of an overall structure of a user terminal according to the present embodiment; and

FIG. 18 is a diagram to show an example of a functional structure of a user terminal according to the present embodiment.

### DESCRIPTION OF EMBODIMENTS

Now, an embodiment of the present invention will be described below in detail with reference to the accompanying drawings. Note that, when the following description mentions a physical downlink control channel (PDCCH), this will include an enhanced physical downlink control channel (EPDCCH: Enhanced PDCCH) as well.

In the LTE-A system, a HetNet (Heterogeneous Network), in which small cells that each have a local coverage area of a radius of approximately several tens of meters are formed within a macro cell having a wide coverage area of a radius of approximately several kilometers, is under study. Carrier aggregation and dual connectivity are applicable to the HetNet structure.

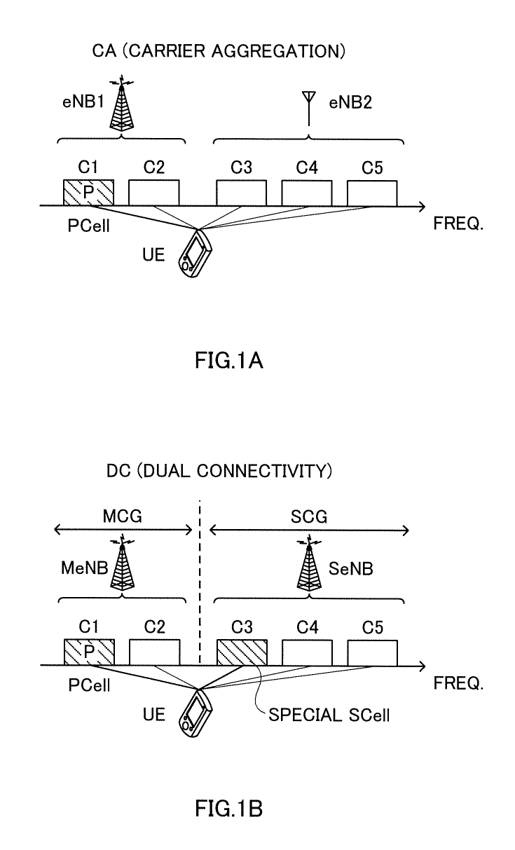

FIG. 1A shows communication between radio base stations and a user terminal in carrier aggregation. In the example shown in FIG. 1A, the radio base station eNB1 is a radio base station to form a macro cell (hereinafter referred to as a “macro base station”), and the radio base station eNB2 is a radio base station to form a small cell (hereinafter referred to as a “small base station”). For example, the small base station may be structured like an RRH (Remote Radio Head) that connects with the macro base station.

When carrier aggregation is employed, one scheduler (for example, a scheduler provided in the macro base station eNB1) controls the scheduling of multiple cells. In a structure in which a scheduler provided in the macro base station eNB1 controls the scheduling of multiple cells, each radio base station may be connected by using, for example, an ideal backhaul that provides a high-speed channel such as optical fiber.

FIG. 1B shows communication between radio base stations and a user terminal in dual connectivity. When dual connectivity is employed, a plurality of schedulers are provided separately, and these multiple schedulers (for example, a scheduler provided in the radio base station MeNB and a scheduler provided in the radio base station SeNB) each control the scheduling of one or more cells they have control over. In a structure in which a scheduler provided in the radio base station MeNB and a scheduler provided in the radio base station SeNB each control the scheduling of one or more cells they have control over, each radio base station may be connected by using, for example, a non-ideal backhaul that produces substantial delays such as the X2 interface.

As shown in FIG. 1B, in dual connectivity, each radio base station configures a cell group (CG) that is comprised of one or a plurality of cells. Each cell group is comprised of one or more cells formed by the same radio base station, or one or more cells formed by the same transmission point such as a transmitting antenna apparatus, a transmission station and so on.

The cell group to include the PCell will be referred to as the “master cell group” (MCG), and cell group(s) other than the master cell group will be referred to as “secondary cell group(s)” (SCG(s)). The total number of the cells to constitute the master cell group and the secondary cell group(s) is configured to be equal to or less than a predetermined value (for example, five cells).

The radio base station where the master cell group is configured will be referred to as the “master base station” (MeNB: Master eNB), and a radio base station where a secondary cell group is configured will be referred to as a “secondary base station” (SeNB: Secondary eNB). The total number of the cells to constitute the master cell group and the secondary cell group(s) is configured to be equal to or less than a predetermined value (for example, five cells).

Dual connectivity does not presume tight cooperation between radio base stations that is equivalent to that used in carrier aggregation. Consequently, a user terminal executes downlink L1/L2 control (PDCCH/EPDCCH) and uplink L1/L2 control (UCI (Uplink Control Information) feedback through the PUCCH/PUSCH) on a per cell group basis. Consequently, secondary base station(s), too, require(s) special SCells that have equal functions to those of the PCell such as common search space, the PUCCH and so on. In the present description, a special SCell having equal functions to those of the PCell will be also referred to as a “PSCell” (Primary Secondary Cell).

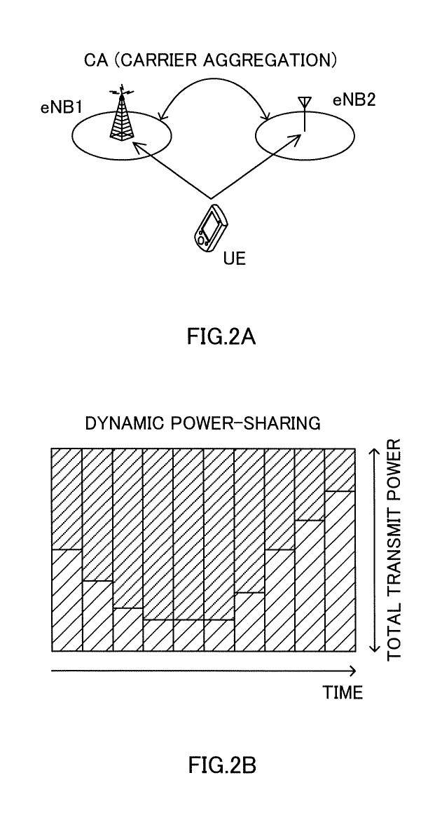

In carrier aggregation, one radio base station (for example, the macro base station eNB1) controls the scheduling of two radio base stations (see FIG. 2A). That is, the macro base station eNB1 can apply transmission power control so that transmission power is adjusted dynamically within a range in which the sum of a user terminal's transmission power for two radio base stations eNB1 and eNB2 does not exceed the maximum possible transmission power (see FIG. 2B).

In dual connectivity, the master base station MeNB and the secondary base station SeNB each make scheduling independently, and therefore transmission power control to adjust transmission power dynamically within a range in which the sum of a user terminal's transmission power for the master base station MeNB and the secondary base station SeNB does not exceed the maximum possible transmission power, is difficult. When the sum transmission power required exceeds the user terminal's maximum possible transmission power, the user terminal performs the process of scaling down the power (power scaling) or dropping part or all of the channels or signals (dropping) until the sum transmission power required reaches a value not exceeding the maximum possible transmission power. Since, in dual connectivity, neither the master base station MeNB nor the secondary base station SeNB is able to know what power control the counterpart radio base station (the secondary base station SeNB for the master base station MeNB and the master base station MeNB for the secondary base station SeNB) is using, there is a fear that the timings and frequency these power scaling and/or dropping may be applied cannot be estimated. When power scaling and/or dropping are unpredictably applied in the master base station MeNB and the secondary base station SeNB, uplink communication can no longer be executed properly, which then gives a fear of a significant deterioration of the quality of communication, throughput and so on.

Furthermore, there is a possibility that dual connectivity can be configured even in scenarios in which the subframe timings are asynchronous between radio base stations or cell groups. In asynchronous dual connectivity, differences between cell groups in subframe transmission timings may assume arbitrary values. In this case, for example, a transmission in a given cell group and a transmission in another cell group may overlap in half a subframe. In this case, there is a fear that only the period of half a subframe where the transmissions for the two cell groups overlap exceeds the maximum possible transmission power, raising a possibility that this part alone may be subject to power scaling and/or dropping.

When power scaling and/or dropping are applied to the whole of a subframe, a radio base station can receive the subframe transmitted and estimate the received power or the amplitude of the subframe by performing channel estimation based on the reference signals included in this subframe, so that there is a possibility that part or all of the signals or channels contained in this subframe can be demodulated properly. However, when power scaling and/or dropping are applied only to part of a subframe, there is a possibility that the received power or the amplitude varies between the reference signals and the data. In this case, a radio base station is unable to know how power scaling and/or dropping have been applied within the subframe, not even by using the reference signals, and there is fear of lowering the possibility that part or all of the signals in the received subframe can be demodulated properly. In this way, in dual connectivity, each radio base station controls transmission power independently, and therefore it is difficult to execute transmission power control in such a way that the sum of a user terminal's transmission power does not exceed the maximum possible transmission power.

So, dual connectivity introduces the concept of “guaranteed transmission power” (minimum guaranteed power) per radio base station or cell group. If the guaranteed transmission power of an xCG (MCG or SCG) is P_{xeNB} (P_{MeNB} or P_{SeNB}), the radio base station xeNB (MeNB or SeNB) reports one or both of the guaranteed transmission powers P_{MeNB} and P_{SeNB} to a user terminal through higher layer signaling such as RRC signaling. When a transmission request arrives from the radio base station xeNB, or when a PUSCH or PUCCH transmission is triggered by uplink grant or by RRC, the user terminal calculates the transmission power for xCG, and, if the transmission power that is required (requested power) is equal to or lower than the guaranteed transmission power P_{xeNB} determines the requested power as the transmission power of xCG.

When the requested power for the radio base station xeNB exceeds the guaranteed transmission power P_{xeNB} the user terminal might control the transmission power to be equal to or lower than the guaranteed transmission power P_{xeNB} depending on conditions. To be more specific, when the sum of the requested powers of the master cell group and the secondary cell group shows a threat of exceeding the user terminal's maximum possible transmission power P_{CMAX}, the user terminal applies power scaling and/or drops the channels or signals, with respect to the cell group where the requested power exceeds the guaranteed transmission power P_{xeNB}. As a result of this, when the transmission power equals to or falls below the guaranteed transmission power P_{xeNB}, power scaling and/or dropping of channels or signals are applied no more.

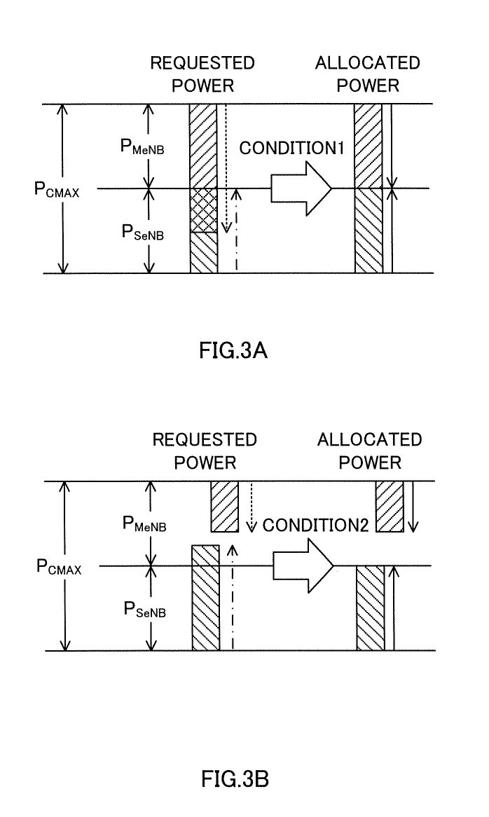

As shown in FIG. 3A, when, in synchronous dual connectivity, the sum of the powers requested from the master base station and the secondary base station at the same timing exceeds a user terminal's maximum possible transmission power P_{CMAX}, the user terminal applies power scaling or dropping to the cell group where the transmission power per cell group that the sum of the transmission power per user terminal does not exceed the maximum possible transmission power P_{CMAX} (condition 1).

As shown in FIG. 3B, when, in asynchronous dual connectivity, a user terminal is unable to know that the requested power in a partially-overlapping period does not exceed the user terminal's maximum possible transmission power P_{CMAX}, the user terminal allocates the transmission power for each cell group to be equal to or lower than the guaranteed transmission power P_{xeNB} (condition 2).

The operations of user terminals will be described in greater detail. First, a user terminal determines, for every CC where uplink transmission takes place, the transmission power required in that CC (requested power per CC) and the maximum possible transmission power P_{CMAX,c} per CC, and compares these. If a CC's requested power exceeds P_{CMAX,c}, the user terminal applies power scaling and/or drops the channels or signals, and makes the transmission power of this CC equal to or lower than P_{CMAX,c}.

Also, the user terminal determines the maximum possible transmission power P_{CMAX} per user terminal. The user terminals adds up every CC's transmission power acquired, on a per cell group basis, and checks whether or not the total sum of every CC's transmission power does not exceed the guaranteed transmission power P_{MeNB} and P_{SeNB} in the master cell group and in the secondary cell group. If the total sum of the CC-specific transmission powers in an arbitrary cell group (xCG, for example) does not exceed the applicable guaranteed transmission power (P_{xeNB} the user terminal determines this transmission power as the transmission power of that cell group. On the other hand, when the total sum of the CC-specific transmission powers in an arbitrary cell group (xCG) exceeds the guaranteed transmission power (P_{xeNB}) applicable to this cell group, the user terminal applies power scaling or dropping, in accordance with predetermined rules, based on the above-noted conditions. Note that, if, as a result of power scaling or dropping, the total sum of the transmission powers of the CCs belonging to the cell group falls below the guaranteed transmission power (P_{xeNB}) applicable to this cell group, no more power scaling or dropping needs to be applied.

The guaranteed transmission power P_{xeNB} is a parameter that is defined per radio base station or cell group, and is configured in the user terminal by the radio base stations through higher layer signaling such as RRC signaling. Assume that the master radio base station MeNB and the secondary radio base station SeNB each at least know the guaranteed transmission power P_{MeNB} or P_{SeNB} of its own cell group. These parameters may be determined in each cell group by the radio base station in control, or it is equally possible to allow the master radio base station MeNB to determine both cell groups' guaranteed transmission powers, and send a report to the secondary radio base station SeNB via backhaul signaling. Also, when determining the guaranteed transmission power, the radio base stations may exchange information such as the user terminal's maximum possible transmission power per CC, the maximum possible transmission power per combination of concurrently-transmitting CCs, and various parameters to use in transmission power control. Furthermore, each radio base station may not only exchange its own guaranteed transmission power, but may also exchange the guaranteed transmission power with one another through backhaul signaling.

Configuring the guaranteed transmission power P_{xeNB} has an advantage for a radio base station that, as long as the power that the subject cell group requests to the user terminal does not exceed the guaranteed transmission power P_{xeNB} the user terminal will certainly allocate the requested power. Consequently, although, in dual connectivity, each radio base station controls transmission power independently, by adequately configuring the guaranteed transmission power P_{xeNB}, it is possible to at least allow a user terminal to guarantee power that is needed for information and signals that are necessary to maintain connections and maintain quality, such as control signals and audio signals, control information such as mobility-related information, and so on.

When the radio base stations exchange information about the user terminal's maximum possible transmission power per CC, the maximum possible transmission power per combination of concurrently-transmitting CCs, various parameters to use in transmission power control, and so on, each radio base station can estimate what transmission power control is used in the counterpart radio base station. For example, if the user terminal's maximum possible transmission power per CC is identified, it is possible to estimate the maximum transmission power with which the user terminal may carry out transmission to the counterpart radio base station.

When a radio base station not only exchanges its own guaranteed transmission power, but also exchanges the guaranteed transmission power with one another, the radio base station can execute scheduling by taking into account the other one's guaranteed transmission power. In this way, the radio base stations MeNB and SeNB exchange information such as various parameters related to user terminal transmission power control, in addition to their own guaranteed transmission power P_{xeNB}, so that it becomes possible to allocate power more adequately.

In synchronous dual connectivity, there is a possibility that the subframe transmission timing differences in a user terminal become approximately several tens of μs at a maximum. Consequently, the user terminal can add up the transmission power of every CC in each cell group, and check whether or not the total sum of the CC-specific transmission powers exceeds the guaranteed transmission power P_{MeNB} and P_{SeNB} in the master cell group and the secondary cell group, and whether or not the total sum of the transmission powers of all CCs in both cell groups exceeds the maximum possible transmission power P_{CMAX}, at the same time.

In synchronous dual connectivity, the user terminal checks, as mentioned earlier, whether or not the total sum of the transmission powers of all CCs exceeds P_{CMAX}, and, if the sum of the requested powers of both cell groups requested from the master base station and the secondary base station at the same timing does not exceed the user terminal's maximum possible transmission power P_{CMAX}, the user terminal allocates the requested powers as transmission power without applying power scaling and/or dropping. On the other hand, when the sum of the requested powers of both cell groups requested from the master base station and the secondary base station at the same timing exceeds the user terminal's maximum possible transmission power P_{CMAX}, the user terminal applies power scaling and/or dropping, and controls the transmission power to be equal to or lower than the maximum possible transmission power P_{CMAX}. Note that power scaling and/or dropping are applied only to the cell groups where transmission power to exceed the guaranteed power is requested.

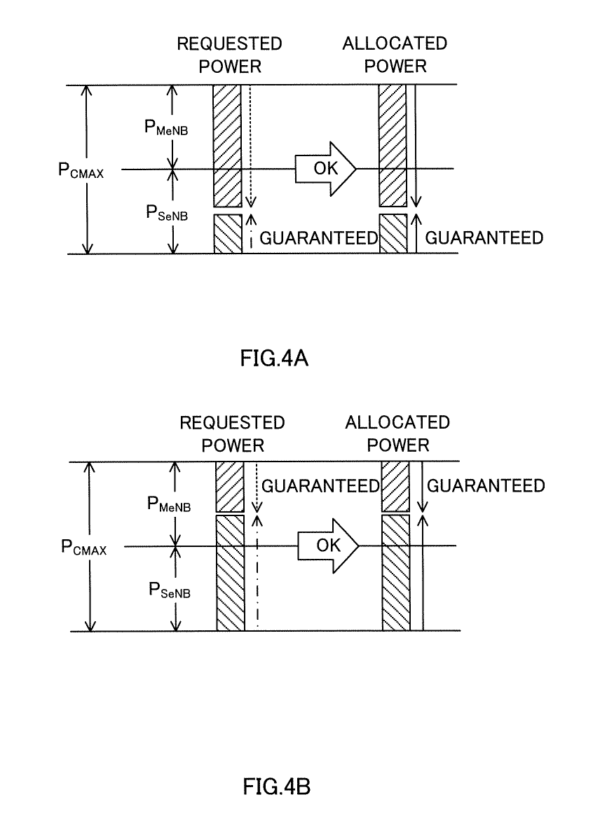

In the example shown in FIG. 4A, power beyond the guaranteed transmission power P_{MeNB} is requested from the master base station, and power that is equal to or lower than the guaranteed transmission power P_{SeNB} is requested from the secondary base station. The user terminal checks whether or not the total sum of the CC-specific transmission powers does not exceed the guaranteed transmission power P_{MeNB} and P_{SeNB} in the master cell group and in the secondary cell group, and whether or not the total sum of the transmission powers of all CCs in both cell group does not exceed the maximum possible transmission power P_{CMAX}. In the example shown in FIG. 4A, the sum of the requested powers of the master cell group and the secondary cell group does not exceed user terminal's maximum possible transmission power P_{CMAX}, so that the user terminal allocates the requested powers of the master cell group and the secondary cell group as transmission power.

In the example shown in FIG. 4B, power that is equal to or lower than the guaranteed transmission power MeNB is requested from the master base station, and power beyond the guaranteed transmission power P_{SeNB} is requested from the secondary base station. The user terminal checks whether or not the total sum of the CC-specific transmission powers does not exceed the guaranteed transmission power P_{MeNB} and P_{SeNB} in the master cell group and in the secondary cell group, and whether or not the total sum of the transmission powers of all CCs in both cell groups does not exceed the maximum possible transmission power P_{CMAX}. In the example shown in FIG. 4B, the sum of the requested powers of the master cell group and the secondary cell group does not exceed the user terminal's maximum possible transmission power P_{CMAX}, so that the user terminal allocates the requested powers of the master cell group and the secondary cell group as transmission power.

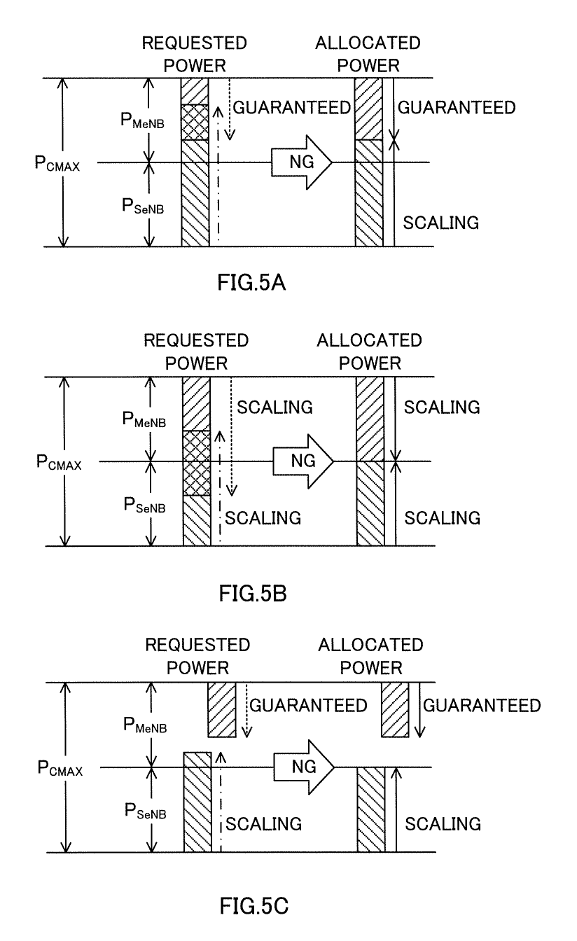

In the example shown in FIG. 5A, power that is equal to or lower than the guaranteed transmission power P_{MeNB} is requested from the master base station, and power beyond the guaranteed transmission power P_{SeNB} is requested from the secondary base station. The user terminal checks whether or not the total sum of the CC-specific transmission powers does not exceed the guaranteed transmission power P_{MeNB} and P_{SeNB} in the master cell group and in the secondary cell group, and whether or not the total sum of the transmission powers of all CCs in both cell groups does not exceed the maximum possible transmission power P_{CMAX}. In this case, the total sum of the transmission powers of all CCs in both cell groups exceeds the maximum possible transmission power P_{CMAX}, so that the user terminal applies power scaling or dropping. To be more specific, while the total sum of the CC-specific transmission powers in the master cell group does not exceed the guaranteed transmission power P_{MeNB} the total sum of the CC-specific transmission powers in the secondary cell group exceeds the guaranteed transmission power P_{SeNB}, so that the user terminal allocates the requested power to the master cell group as transmission power, and allocates the rest of the power (the remaining power that is left after the master cell group's transmission power is subtracted from the maximum possible transmission power P_{CMAX}) to the secondary cell group. The user terminal sees this remaining power as the maximum possible transmission power for the secondary cell group, and applies power scaling or dropping to the secondary cell group.

For the rules for applying power scaling and dropping described above, the rules stipulated in Rel. 10/11 can be applied. Rel. 10/11 provides for the rules of power scaling and/or dropping for when there are concurrent transmissions in a plurality of CCs in CA, for when the requested transmission powers of all CCs exceeds the maximum possible transmission power P_{CMAX} per user terminal, and so on. By using the above-noted remaining power (the remaining power that is left after the master cell group's transmission power is subtracted from the maximum possible transmission power P_{CMAX}) as the maximum possible transmission power, and the transmission power that is requested in this cell group as the requested transmission power, it is possible to apply power scaling and/or dropping to this cell group based on the rules stipulated in Rel. 10/11. These can be made possible with mechanisms that have been stipulated heretofore, so that the user terminal can easily realize transmission power control and the rules of power scaling and/or dropping by re-cycling existing mechanisms, without introducing new mechanisms.

In the example shown in FIG. 5B, power beyond the guaranteed transmission power P_{MeNB} is requested from the master base station, and power beyond the guaranteed transmission power P_{SeNB} is requested from the secondary base station, too. The user terminal checks whether or not the total sum of the CC-specific transmission powers does not exceed the guaranteed transmission power P_{MeNB} and P_{SeNB} in the master cell group and in the secondary cell group, and whether or not the total sum of the transmission powers of all CCs in both cell groups does not exceed the maximum possible transmission power P_{CMAX} In this case, the total sum of the transmission powers of all CCs in both cell groups exceeds the maximum possible transmission power P_{CMAX}, so that the user terminal applies power scaling or dropping. To be more specific, the total sum of the CC-specific transmission powers in the master cell group exceeds the guaranteed transmission power P_{MeNB} and the total sum of the CC-specific transmission powers in the secondary cell group exceeds the guaranteed transmission power P_{SeNB}, so that the user terminal applies power scaling or dropping to the master cell group and the secondary cell group, and controls each cell group's transmission power to be equal to or lower than the guaranteed transmission power P_{MeNB} and the guaranteed transmission power P_{SeNB}. In this case, again, for the rules of power scaling and/or dropping for both cell groups, the rules stipulated in Rel. 10/11 can be applied. The user terminal may see the guaranteed transmission power P_{MeNB} and P_{SeNB} as the maximum possible transmission power of each cell group, calculate the requested power in each cell group, apply power scaling and/or dropping, per cell group, based on the rules stipulated in Rel. 10/11, and control the transmission power in each cell group to be equal to or lower than the guaranteed transmission power P_{MeNB} or P_{SeNB}.

In asynchronous dual connectivity, cases might occur where, at the time a user terminal starts an uplink transmission for a cell group at a preceding timing, the user terminal is unable to identify the requested power that is needed for an uplink transmission for a cell group at a subsequent timing. In this case, the user terminal assumes that the guaranteed transmission power P_{xeNB} is the maximum transmission power per radio base station or per cell group, and executes transmission power control. The guaranteed transmission power is configured to be exclusive between cell groups—that is, to hold P_{MeNB}+P_{SeNB}≦P_{CMAX}. Consequently, even in asynchronous dual connectivity, in which a user terminal has difficulty allocating power adequately between cell groups, by making a proportion to match the guaranteed transmission power P_{xeNB} the maximum possible transmission power of each cell group, it is possible to control power adequately, without influencing each other's transmission power between cell groups having varying transmission timings.

In the example shown in FIG. 5C, at the preceding timing, the user terminal is unable to identify the power to be requested at the following timing. At the preceding timing, power beyond the guaranteed transmission power P_{SeNB} is requested from the secondary base station, and, at the following timing, power that is equal to or lower than the guaranteed transmission power P_{MeNB} is requested from the master base station. In this case, the user terminal guarantees the requested power of the master cell group, and allocates this requested power as transmission power. As for the transmission power for the secondary base station, the user terminal allocates power that is scaled with respect to the guaranteed transmission power P_{SeNB} as the maximum transmission power.

The user terminal guarantees the allocation of power if power that is requested is equal to or lower than the guaranteed transmission power P_{xeNB}, regardless of whether synchronization or asynchronization is assumed, whether the radio base station or cell group is a different radio base station or cell group, and so on. When the requested power exceeds the guaranteed transmission power P_{xeNB} the user terminal allocates the requested power as transmission power only if the allocation is judged possible.

Note that, even during asynchronous dual connectivity, cases occur where the user terminal can judge that power beyond the guaranteed transmission power P_{xeNB} can be allocated. Examples of this kind might include the case where only one cell group has transitioned to the DRX state, the case where at least one of the cell group uses TDD, and so on. When one cell group has transitioned to the DRX state, no uplink data transmission takes place in this cell group. Also, if one cell group uses TDD, no uplink transmission takes place in this cell in time periods for downlink communication (for example, DL subframes, special subframes and so on).

If the user terminal knows in advance these timings where uplink transmission does not take place, even in the event of asynchronous dual connectivity, the user terminal can allocate power beyond the guaranteed transmission power. Also, in this case, the user terminal checks, as in the event of synchronous dual connectivity, whether the total sum of the transmission powers of all CCs exceeds P_{CMAX} in an arbitrary timing, and, if the sum of the requested power of both cell groups, requested from the master base station and the secondary base station at the same timing, does not exceed the user terminal's maximum possible transmission power P_{CMAX}, the user terminal can allocate the requested power as transmission power without applying power scaling and/or dropping.

The guaranteed transmission power may be configured so that the sum of P_{MeNB} and P_{SeNB} becomes a smaller value than the user terminal's maximum possible transmission power P_{CMAX}. In this case, a non-guaranteed power area, where neither radio base station is guaranteed power allocation, is produced. In the non-guaranteed power area, power is allocated according to different priorities from those of the guaranteed power area, instead of guaranteeing power for each radio base station. For example, non-guaranteed power that is left after each radio base station is given its share of guaranteed power may be distributed based on the priorities of each radio base station's channels, signals, and so on. The priorities of channels and signals may be, for example, MCG PUCCH>SCG PUCCH>MCG PUSCH>SCG PUSCH. The priorities of channels and signals may be, for example, MCG SR>SCG SR>MCG HARQ-ACK>SCG HARQ-ACK>MCG data>SCG data>MCG CQI>SCG CQI. However, the priorities of channels and signals are by no means limited to these.

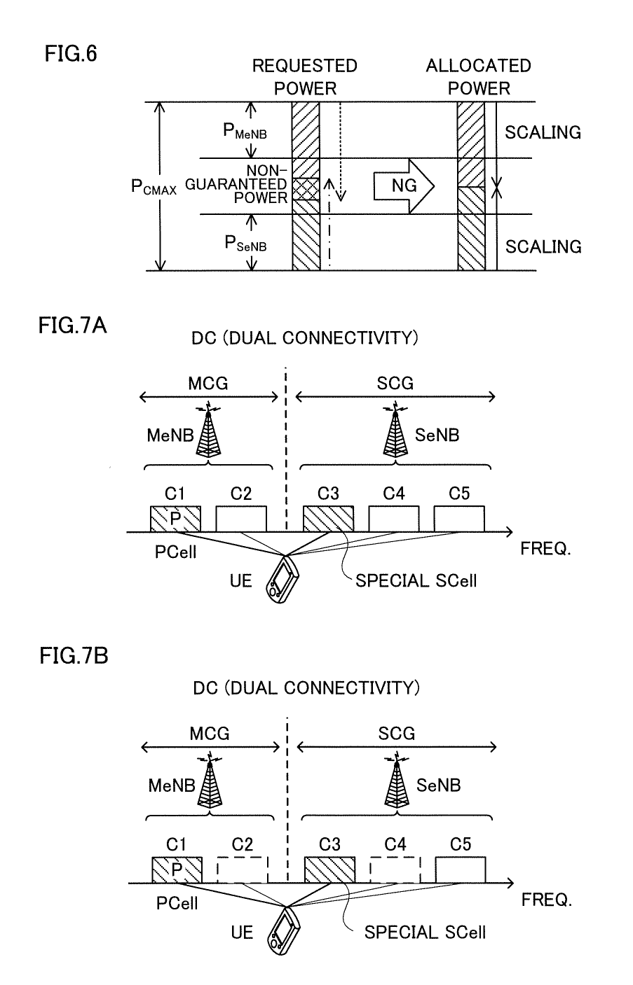

In the example shown in FIG. 6, since the sum of the guaranteed transmission power P_{MeNB} and P_{SeNB} is configured to be a smaller value than the user terminal's maximum possible transmission power P_{CMAX}, a non-guaranteed power area is produced. Power beyond the guaranteed power beyond the guaranteed transmission power P_{SeNB} is requested from the secondary base station. In this case, the user terminal scales the transmission power or drops the signals depending on the types of the channels and/or signals of each radio base station, and allocates non-guaranteed power to each radio base station as transmission power.

In dual connectivity, carrier aggregation can be executed within a radio base station or within a cell group. In carrier aggregation, configuration or removal of CCs is commanded by RRC signaling. Furthermore, activation or de-activation of CCs is commanded by MAC signaling. A radio base station can also command deactivation to user terminals by configuring a deactivation timer (deactivation time) in the MAC layer. By implementing the activation or deactivation of CCs by using dynamic commands through the MAC layer depending on the traffic for user terminals, it is possible to reduce the power consumption of user terminals. However, assume that the PCell and special SCells (PSCells) are always in the active state.

FIG. 7A shows an example in which all cells (cells C1 to C5) are in the active state. FIG. 7B shows an example in which an SCell (cell C2) in the master cell group (MCG) and one (cell C4) of the SCells in the secondary cell group (SCG) are in the non-active state. Considering that greater transmission power is required as the number of concurrently-transmitting CCs increases, there is a possibility that the transmission power per cell group which a radio base station wants to guarantee varies depending on the number of cells in the active state. In this case, if RRC signaling to configure the guaranteed transmission power P_{xeNB} is applied as frequently as MAC layer-based activation control is, the overhead and the delays grow, and the throughput lowers.

By contrast with this, regarding the user terminal operations when guaranteed power is configured in dual connectivity, the present inventors have arrived at a structure in which a radio base station configures the guaranteed transmission power P_{xeNB} on a per cell (CC) basis, and reports these to a user terminal. According to this method, it is possible to configure adequate guaranteed transmission power depending on the number of cells in the active state.

Now, a structure in which a radio base station configures guaranteed transmission power P_{xeNB} on a per cell (CC) basis and reports these to a user terminal will be described below in detail.

### First Example

A structure will be described with a first example where a radio base station reports the value of the guaranteed transmission power P_{xeNB} (P_{xeNB,c}) of each cell (CC) to a user terminal through higher layer signaling such as RRC signaling. The user terminal determines the guaranteed transmission power P_{xeNB} depending on the number of cells in the active state and the number of cells.

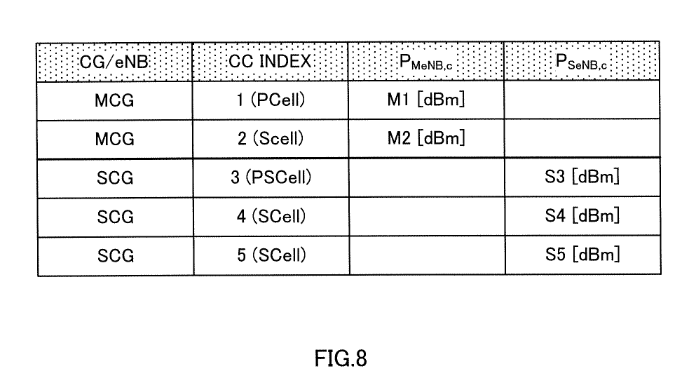

A radio base station and a user terminal share a common table, in which, as shown in FIG. 8, the values of guaranteed transmission power P_{xeNB} (P_{xeNB,c}) are specified on a per cell (CC) basis. The table shown in FIG. 8 illustrates a case where the master cell group and the secondary cell group are formed with five cells (CCs). The user terminal can determine the number of cells in the active state and the number of cells. In the table shown in FIG. 8, the values of “cell group/radio base station,” “CC index,” “guaranteed transmission power P_{MeNB,c}” and “guaranteed transmission power P_{SeNB,c}” are specified.

In the table shown in FIG. 8, guaranteed transmission power P_{MeNB,1}=M1 [dBm] is configured for a cell 1 (PCell) belonging to the master cell group (MCG), and guaranteed transmission power P_{MeNB,2}=M2 [dBm] is configured for a cell 2 (SCell) belonging to the master cell group (MCG). Guaranteed transmission power P_{SeNB,3}=S3 [dBm] is configured for a cell 3 (PSCell) belonging to the secondary cell group (SCG), guaranteed transmission power P_{SeNB,4}=S4 [dBm] is configured for a cell 4 (SCell) belonging to the secondary cell group (SCG), and guaranteed transmission power P_{SeNB,5}=S5 [dBm] is configured for a cell 5 (SCell) belonging to the secondary cell group (SCG).

Referring to the table shown in FIG. 8, the sum of the guaranteed transmission powers P_{xeNB,c} of all cells becomes equal to or less than the user terminal's maximum possible transmission power P_{CMAX}. That is, the user terminal's maximum possible transmission power P_{CMAX}≦M1+M2+S3+S4+S5 [dBm] holds.

For example, if cell 3 and cell 5 belonging to the secondary cell group (SCG) are in the active state, according to the table shown in FIG. 8, guaranteed transmission power P_{SeNB,3}=S3 [dBm] applies to cell 3, and guaranteed transmission power P_{SeNB,5}=S5 [dBm] applies to cell 5. Consequently, the guaranteed transmission power P_{SeNB} for the secondary cell group is determined to be P_{SeNB}=10 log₁₀{10^{(53/10)}+10^{(S5/10)}} [dBm].

The values of guaranteed transmission power P_{xeNB,c} are not absolute values, and may be expressed as proportions [%] of the user terminal's maximum possible transmission power P_{CMAX}, P_{CMAX}_{_}_{H} or P_{CMAX}_{_}_{L}. The maximum possible transmission power P_{CMAX} is a value to be selected by the user terminal, and is allowed to vary on a certain level between P_{CMAX}_{_}_{L} and P_{CMAX}_{_}_{H} between subframes. When the values of guaranteed transmission power P_{xeNB,c} are expressed as proportions [%] of the user terminal's maximum possible transmission power P_{CMAX}, the values of guaranteed transmission power P_{xeNB,c} are configured to give a sum of 100 [%], so that it is possible to allocate all the transmission power which the user terminal can use to each CC as guaranteed power, regardless of the result of the selection of the value of the maximum possible transmission power P_{CMAX} by the user terminal, thereby making possible power control with little inefficiency. Meanwhile, since P_{CMAX}_{_}_{H} is a semi-static parameter which the radio base stations configure in the user terminal, when the values of guaranteed transmission power P_{xeNB,c} are expressed as proportions [%] of P_{CMAX}_{_}_{H}, guaranteed transmission power P_{xeNB,c} does not show fluctuations which the radio base stations cannot comprehend. Consequently, reliable transmission power control becomes possible. Also, P_{CMAX}_{_}_{L} is the worst value (minimum value) among the values of maximum possible transmission power P_{CMAX} which the user terminal might configure. Consequently, when the values of guaranteed transmission power P_{xeNB,c} are expressed as proportions [%] of P_{CMAX}_{_}_{L} the values of guaranteed transmission power P_{xeNB,c} can be configured as values at which the user terminal should be able to make transmission at any arbitrary timing, regardless of the mode of implementation of the user terminal (minimum requirement).

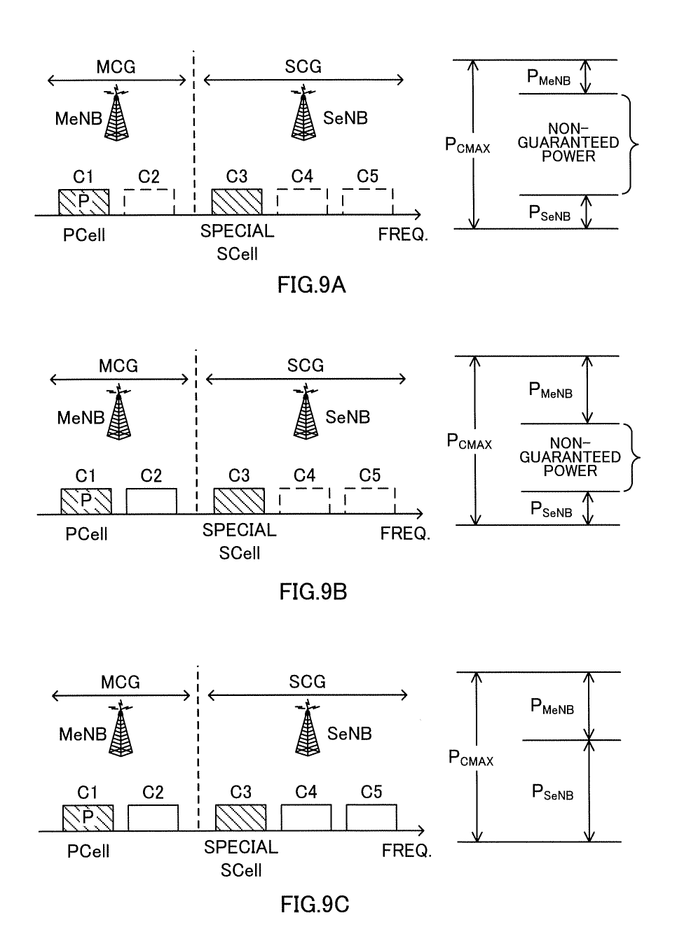

Now, the method in which the user terminal configures guaranteed power depending on the number of cells in the active state will be described with reference to FIG. 9. In the state shown in FIG. 9A, only the PCell (cell C1) is active in the master cell group (MCG), and only the special SCell (cell C3) is active in the secondary cell group (SCG). The user terminal, based on the table shown in FIG. 8, determines the guaranteed transmission power P_{MeNB} of the master cell group and the guaranteed transmission power P_{SeNB} of the secondary cell group. At this time, non-guaranteed power is produced because the sum of the guaranteed transmission power P_{MeNB} and the guaranteed transmission power P_{SeNB} does not exceed the user terminal's maximum possible transmission power P_{CMAX}.

In the state shown in FIG. 9B, the SCell (cell C2) in the master cell group (MCG) is additionally made active, compared to the state shown in FIG. 9A. The user terminal determines the master cell group's guaranteed transmission power P_{MeNB} again based on the table shown in FIG. 8. Since the number of cells in the active state has increased and the guaranteed power has grown, there is less non-guaranteed power than in the state shown in FIG. 9A.

In the state shown in FIG. 9C, two SCells (cell C4 and C5) in the secondary cell group (SCG) are additionally made active, from the state shown in FIG. 9B. That is, in the state shown in FIG. 9C, all cells are in the active state. The user terminal determines the secondary cell group's guaranteed transmission power P_{SeNB} again based on the table shown in FIG. 8 In this example, unguaranteed power no longer exists because the sum of the guaranteed transmission power P_{MeNB} and the guaranteed transmission power P_{SeNB} is equal to the user terminal's maximum possible transmission power P_{CMAX}.

The radio base stations configure the guaranteed transmission power P_{xeNB} (P_{xeNB,c}) of each cell (CC) and report these to the user terminal, so that the user terminal can adequately configure guaranteed power depending on the number of cells in the active state. When the number of cells in the active state is small, it is not necessary to guarantee large power, so that non-guaranteed power can be produced. Non-guaranteed power is power that is available for use to specific or all base stations. However, since non-guaranteed power is power that is not guaranteed by any of the base stations, there is a possibility that the user terminal does not allocate power, depending on the situation.

By increasing the guaranteed power when the number of cells in the active state grows, greater guaranteed power can be secured for cell groups that require large transmission power. Also, since it is not necessary to re-configure the guaranteed power through RRC signaling in accordance with activation/deactivation, it is possible to reduce the frequency of RRC signaling and reduce the overhead. Also, since the guaranteed transmission power P_{xeNB} can be changed by using MAC signaling that produces little delay, it is possible to achieve improved delay performance.

The master base station and the secondary base station may share and hold the table shown as an example in FIG. 8, or the master base station may hold only the rows pertaining to the master cell group (MCG), and the secondary base station may hold only the rows pertaining to the secondary cell group (SCG). When a common table is held, it is possible to perform scheduling taking into account the power that is guaranteed in both cell groups, so that efficient power allocation can be expected. When each cell group holds only the rows pertaining thereto, it is no longer necessary to signal all the elements in the table, so that reduced overhead can be expected.

The table does not have to hold all CCs' guaranteed transmission powers that are configured. In FIG. 8, for example, when guaranteed power is not configured in the SCell of CC index #5, a table without rows for the SCell of CC index #5 may be held. When guaranteed transmission power is not configured, the user terminal understands that the guaranteed transmission power=0. In this way, no table is configured with respect to CCs with guaranteed transmission power=0, so that it is possible to reduce the signaling overhead and reduce the volume of memory needed in the radio base stations or the user terminal.

### Second Example

When, as shown with the first example, guaranteed transmission power P_{xeNB} is configured per cell, non-guaranteed power is produced if the number of cells in the active state is small compared to the number of cells configured in a cell group. By contrast with this, there is a need to use as much as power as possible as guaranteed power regardless of the number of cells in the active state. So, with a second example, a structure to configure guaranteed transmission power P_{xeNB} per combination of cells in the active state will be described.

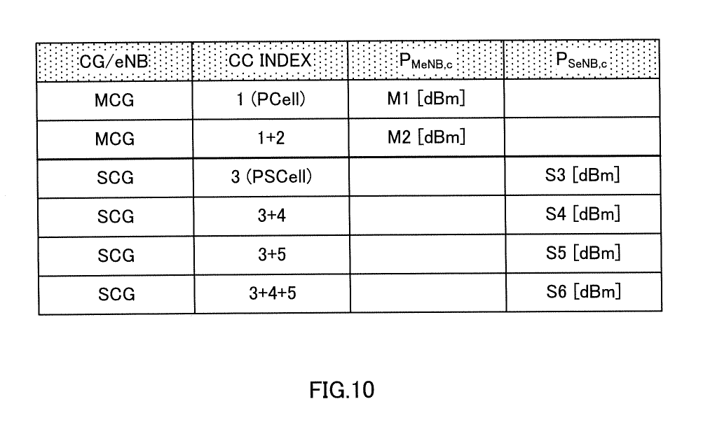

A radio base station and a user terminal hold a common table in which, as shown in FIG. 10, the values of guaranteed transmission power P_{xeNB} (P_{xeNB,c}) are specified per cell or per combination of cells. According to the table shown in FIG. 10, guaranteed transmission power P_{MeNB,1}=M1 [dBm] is configured for a cell 1 (PCell) belonging to the master cell group (MCG), guaranteed transmission power P_{MeNB,1+2}=M2 [dBm] is configured for the combination of cells 1 and 2 (cell 1+2) belonging to the master cell group (MCG). Guaranteed transmission power P_{SeNB,3}=S3 [dBm] is configured for a cell 3 (PSCell) belonging to the secondary cell group (SCG), guaranteed transmission power P_{SeNB,3+4}=S4 [dBm] is configured for the combination of cells 3 and 4 (cell 3+4) belonging to the secondary cell group (SCG), guaranteed transmission power P_{SeNB,3+5}=S5 [dBm] is configured for the combination of cells 3 and 5 (cell 3+5) belonging to the secondary cell group (SCG), and guaranteed transmission power P_{SeNB,3+4+5}=S6 [dBm] is configured for the combination of cells 3, 4 and 5 (cell 3+4+5) belonging to the secondary cell group (SCG).

Cell 1 (PCell) belonging to the master cell group (MCG) and cell 3 (PSCell) belonging to the secondary cell group (SCG) are always in the active state, and never in the non-active state.

For example, when cell 3 and cell 5 belonging to the secondary cell group (SCG) are in the active state, guaranteed transmission power P_{SeNB,3+5}=S5 [dBm] is determined for the secondary cell group, according to the table shown in FIG. 10.

The values of guaranteed transmission power P_{xeNB,c} are not absolute values, as in the first example, and may be proportions [%] of the user terminal's maximum possible transmission power P_{CMAX}, P_{CMAX}_{_}_{H} or P_{CMAX}_{_}_{L}.

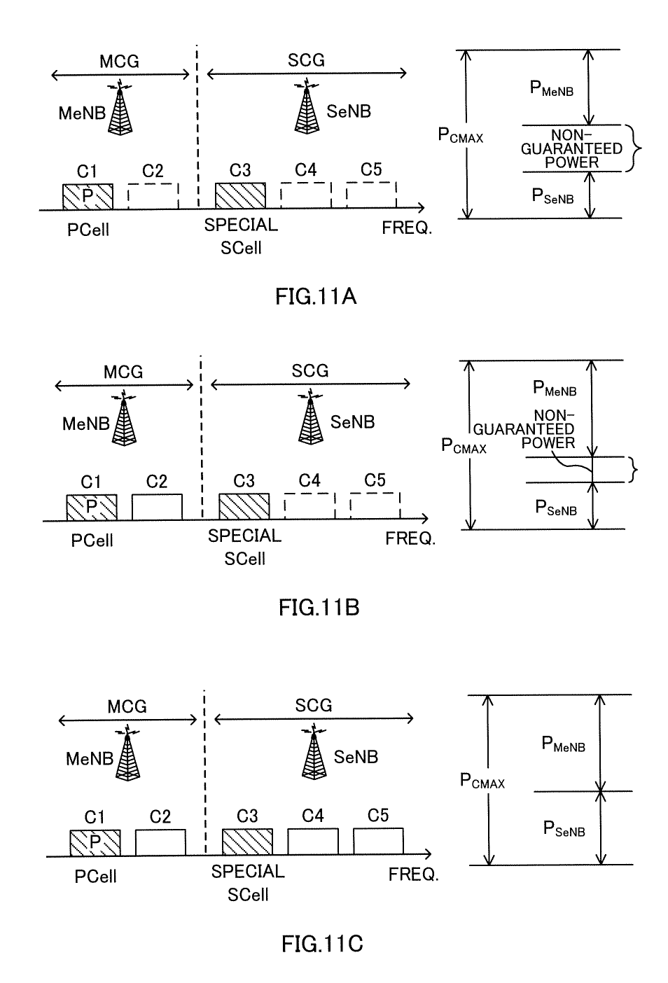

Now, the method in which the user terminal configures guaranteed power depending on the number of cells in the active state will be described with reference to FIG. 11. In the state shown FIG. 11A, only the PCell (cell C1) is active in the master cell group (MCG), and, in the secondary cell group (SCG), only the special SCell (cell C3) is active. The user terminal determines the guaranteed transmission power P_{MeNB} of the master cell group and the guaranteed transmission power P_{SeNB} of the secondary cell group based on the table shown in FIG. 10. According to the table shown in FIG. 10, guaranteed transmission power P_{MeNB}=P_{MeNB,1}=M1 [dBm] applies to the master cell group, and guaranteed transmission power P_{SeNB}=P_{SeNB,3}=S3 [dBm] applies to the secondary cell group. At this time, non-guaranteed power is produced because the sum of the guaranteed transmission power P_{MeNB} and the guaranteed transmission power P_{SeNB} does not exceed the user terminal's maximum possible transmission power P_{CMAX}.

In the state shown in FIG. 11B, the SCell (cell C2) in the master cell group (MCG) is additionally made active from the state shown in FIG. 11A. The user terminal determines the master cell group's guaranteed transmission power P_{MeNB} again based on the table shown in FIG. 10. According to the table shown in FIG. 10, guaranteed transmission power P_{MeNB}=P_{MeNB,1+2}=M2 [dBm] apples to the master cell group.

In the state shown in FIG. 11C, two SCells (cells C4 and C5) in the secondary cell group (SCG) are additionally made active from the state shown in FIG. 11B. That is, all cells are in the active state in the state shown in FIG. 11C. The user terminal determines the secondary cell group's guaranteed transmission power P_{SeNB} again based on the table shown in FIG. 10. According to the table shown in FIG. 10, guaranteed transmission power P_{SeNB}=P_{SeNB,3+4+5}=S6 [dBm] applies to the secondary cell group. In this example, non-guaranteed power does not exist because the sum of the guaranteed transmission power P_{MeNB} and the guaranteed transmission power P_{SeNB} is equal to the user terminal's maximum possible transmission power P_{CMAX}.

According to the second example, compared to when using the table of the first example, it is possible to reduce the non-guaranteed power (see FIG. 9 and FIG. 11). Consequently, even when the number of cells in the active state is small, it is possible to allocate large guaranteed power to radio base station or cell groups.

According to the second example, fixed P_{MeNB}/P_{SeNB} values are configured regardless of the combination of cells in the active state, it is possible to make P_{MeNB}/P_{SeNB} always fixed regardless of the number of cells in the active state. By this means, more flexible operations of guaranteed power allocation become possible.

The master base station and the secondary base station may share and hold the table shown as an example in FIG. 10, or the master base station may hold only the rows pertaining to the master cell group (MCG), and the secondary base station may hold only the rows pertaining to the secondary cell group (SCG). When a common table is held, it is possible to perform scheduling taking into account the power that is guaranteed in both cell groups, so that efficient power allocation can be expected. When each cell group holds only the rows pertaining thereto, it is no longer necessary to signal all the elements in the table, so that reduced overhead can be expected.

The table does not have to hold all CCs' guaranteed transmission powers that are configured. In FIG. 10, for example, when guaranteed power is not configured in the SCell of CC index #5, a table without rows for CC index #3+#5 and CC index #3+#4+#5 may be held. When guaranteed transmission power is not configured, the user terminal understands that the guaranteed transmission power=0. In this way, no table is configured with respect to CCs with guaranteed transmission power=0, so that it is possible to reduce the signaling overhead and reduce the volume of memory needed in the radio base stations or the user terminal.

### Third Example

A structure will be described with a third example where a user terminal reports the PHR (Power HeadRoom) to radio base stations following activation or deactivation of SCells.

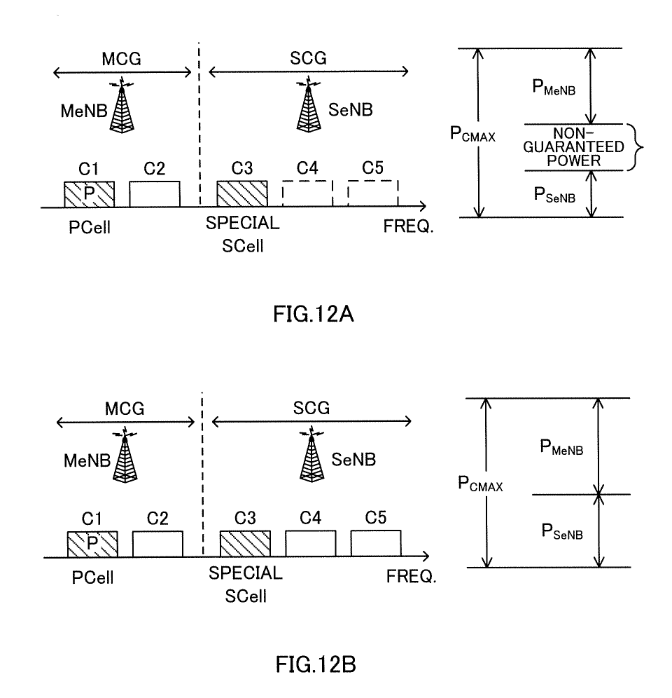

In the state shown in FIG. 12A, the PCell (cell C1) and the SCell (cell C2) are active in the master cell group (MCG), and, in the secondary cell group (SCG), only the special SCell (cell C3) is active. At this time, seen from the master base station's perspective, a non-guaranteed power area exists in the area beyond the guaranteed transmission power P_{MeNB}.

In the state shown in FIG. 12B, the PCell (cell C1) and the SCell (cell C2) are active in the master cell group (MCG), and, in the secondary cell group (SCG), the special SCell (cell C3) and the SCells (cells C4 and C5) are active. At this time, seen from the master base station's perspective, the area of the secondary base station's guaranteed transmission power P_{SeNB} is present in the area beyond the guaranteed transmission power P_{MeNB}.

If the secondary base station activates the SCells in the state shown in FIG. 12A, the state shown in FIG. 12B is given. If the secondary base station deactivates the SCells in the state shown in FIG. 12B, the state shown in FIG. 12A is given. Seen from the master base station's perspective, whether the area of the secondary base station's guaranteed transmission power P_{SeNB} is present or a non-guaranteed power area is present in the area beyond the guaranteed transmission power P_{MeNB} varies depending on whether the SCells of the secondary cell group are in the active state or the non-active state.

When a given radio base station or cell group activates or deactivates cells, the other radio base stations or cell groups engaged in dual connectivity need to know this. In the examples shown in FIG. 12, the user terminal's power allocation priority operation varies depending on whether the area of the secondary base station's guaranteed transmission power P_{SeNB} is present or a non-guaranteed power area is present in the area beyond the guaranteed transmission power P_{MeNB}, and, if the master base station is unable to know which area is present, it becomes difficult to adequately allocate power beyond the guaranteed transmission power P_{MeNB}.

However, activation or deactivation of cells is commanded through MAC signaling, and therefore it is not possible to exchange information dynamically between the radio base stations.

So, when SCells are activated or deactivated, the user terminal reports the PHR (Power HeadRoom) to all the radio base stations. A flag bit to indicate which cells are in the active state is provided in the PHR, and enables each radio base station to know which cells are in the active state. The activation of cells is triggered by an activation command, which provided from the radio base stations via MAC signaling. The deactivation of cells is triggered upon expiration of the deactivation timer (deactivation time), or by a deactivation command that is provided from the radio base stations via MAC signaling.

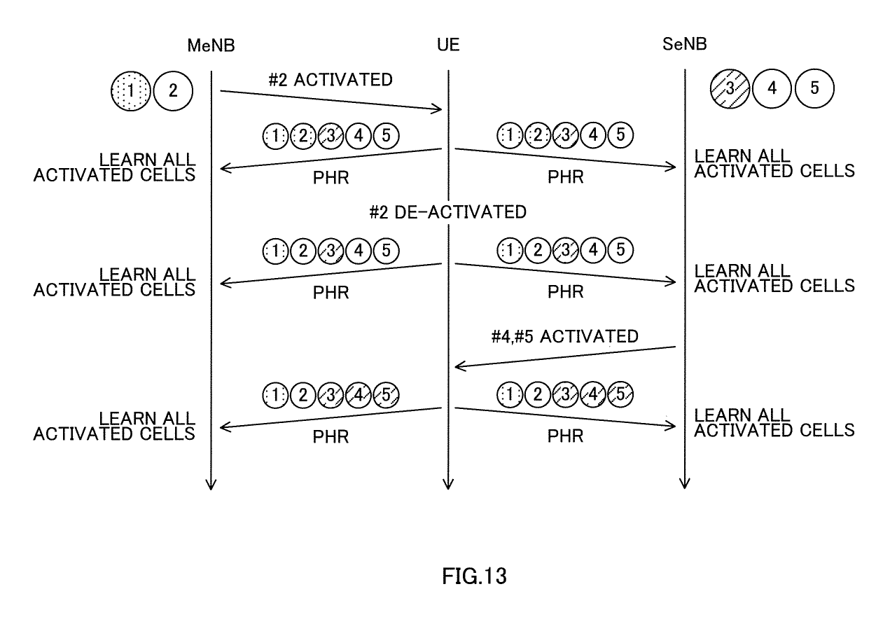

Now, the method in which the user terminal reports the PHR to the radio base stations upon activation or deactivation of SCells will be described with reference to FIG. 13. First, assume that, for the user terminal, the PCell (#1) belonging to the master cell group and the PSCell (#3) belonging to the secondary cell group are in the active state.

After that, the master base station MeNB activates the SCell (#2). The user terminal reports the PHR to the master base station MeNB and the secondary base station SeNB. The master base station MeNB and the secondary base station SeNB know the guaranteed transmission powers P_{MeNB} and P_{SeNB} each other and also know how much non-guaranteed power there is, and each control the transmission power independently. The master base station MeNB and the secondary base station SeNB recognize that the non-guaranteed power has decreased compared to the earlier stage in which the PCell (#1) and the PSCell (#3) were in the active state.

After that, the master base station MeNB deactivates the SCell (#2). The user terminal reports the PHR to the master base station MeNB and the secondary base station SeNB. The master base station MeNB and the secondary base station SeNB know the guaranteed transmission powers P_{MeNB} and P_{SeNB} each other, and also know how much non-guaranteed power there is, and each control the transmission power independently. The master base station MeNB and the secondary base station SeNB recognize that the non-guaranteed power has decreased compared to the earlier stage in which the PCell (#1), the SCell (#2) and the PSCell (#3) were active.

After that, the secondary base station SeNB activates the SCells (#4 and #5). The user terminal reports the PHR to the master base station MeNB and the secondary base station SeNB. The master base station MeNB and the secondary base station SeNB know the guaranteed transmission powers P_{MeNB} and P_{SeNB} each other, and also know how much non-guaranteed power there is, and each control the transmission power independently. The master base station MeNB and the secondary base station SeNB recognize that the non-guaranteed power has decreased compared to the earlier stage in which the PCell (#1) and the PSCell (#3) were active.

In this way, by reporting the PHR from the user terminal to the radio base stations following activation or deactivation of SCells, it becomes possible to control activation and deactivation so that power is used effectively.

Also, a radio base station can adequately recognize when other radio base stations enter the active state, with little delay, and control the transmission power adequately depending on traffic and how much room is left in the user terminal's transmission power. For example, a radio base station can recognize when the number of cells in the active state under other radio base stations decreases, and activate the cells under the subject base station additionally. Although the subject base station's guaranteed power increases by this additional activation, the user terminal reports the PHR following the activation, so that it is possible to report to other radio base stations that the subject base station's guaranteed power has increased. For example, it is also possible to recognize when the number of cells in the active state increases, and limit allocating power to the cells of the subject base station beyond the guaranteed power.

### Fourth Example

In LTE Rel. 12, studies are in progress to divide subframes into subframe sets and apply transmission power control individually for eIMTA (enhanced Interference Management and Traffic Adaptation) or for dynamic TDD. Even in cells belonging to the master base station or the secondary base station in dual connectivity, there is a possibility that transmission power control is executed on a per subframe set basis.

When transmission power control is applied on a per subframe set basis, there is a possibility that the transmission power that is required varies in every subframe set. Consequently, when the subframe set-specific transmission power control functions for eITMA are used, it is not preferable if there is only one value of guaranteed transmission power P_{xeNB}.

So, when transmission power control is applied on a per subframe set basis, it is allowed to configure the guaranteed transmission power P_{xeNB} in different values on a per subframe set basis. For example, guaranteed transmission power P_{MeNB,1} or P_{SeNB,1} is configured for a subframe set 1, and guaranteed transmission power P_{MeNB,2} or P_{SeNB,2} is configured for a subframe set 2.

By this means, it is possible to configure the guaranteed transmission power P_{xeNB} in different values on a per subframe set basis. This structure is applicable to TDD+FDD-dual connectivity and so on.

(Structure of Radio Communication System)

Now, the structure of the radio communication system according to the present embodiment will be described below. In this radio communication system, a radio communication method to execute the above-described transmission power control is employed.

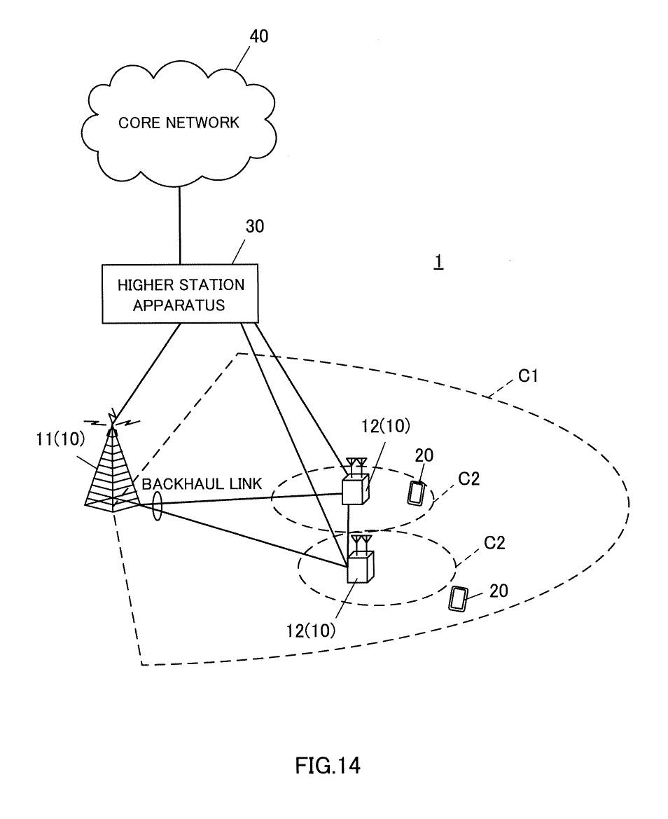

FIG. 14 is a schematic structure diagram to show an example of the radio communication system according to the present embodiment. As shown in FIG. 14, a radio communication system 1 is comprised of a plurality of radio base stations 10 (11 and 12), and a plurality of user terminals 20 that are present within cells formed by each radio base station 10 and that are configured to be capable of communicating with each radio base station 10. The radio base stations 10 are each connected with a higher station apparatus 30, and are connected to a core network 40 via the higher station apparatus 30.

In FIG. 14, the radio base station 11 is, for example, a macro base station having a relatively wide coverage, and forms a macro cell C1. The radio base stations 12 are, for example, small base stations having local coverages, and form small cells C2. Note that the number of radio base stations 11 and 12 is not limited to that shown in FIG. 14.

In the macro cell C1 and the small cells C2, the same frequency band may be used, or different frequency bands may be used. Also, the radio base stations 11 and 12 are connected with each other via an inter-base station interface (for example, optical fiber, the X2 interface, etc.).

Between the radio base station 11 and the radio base stations 12, between the radio base station 11 and other radio base stations 11, or between the radio base stations 12 and other radio base stations 12, dual connectivity (DC) or carrier aggregation (CA) is employed.

User terminals 20 are terminals to support various communication schemes such as LTE, LTE-A and so on, and may include both mobile communication terminals and stationary communication terminals. The user terminals 20 can communicate with other user terminals 20 via the radio base stations 10.

The higher station apparatus 30 may be, for example, an access gateway apparatus, a radio network controller (RNC), a mobility management entity (MME) and so on, but is by no means limited to these.

In the radio communication system 1, a downlink shared channel (PDSCH: Physical Downlink Shared Channel), which is used by each user terminal 20 on a shared basis, downlink control channels (PDCCH (Physical Downlink Control Channel), EPDCCH (Enhanced Physical Downlink Control Channel), etc.), a broadcast channel (PBCH) and so on are used as downlink channels. User data, higher layer control information and predetermined SIBs (System Information Blocks) are communicated in the PDSCH. Downlink control information (DCI) is communicated by the PDCCH and the EPDCCH.

Also, in the radio communication system 1, an uplink shared channel (PUSCH: Physical Uplink Shared Channel), which is used by each user terminal 20 on a shared basis, an uplink control channel (PUCCH: Physical Uplink Control Channel) and so on are used as uplink channels. User data and higher layer control information are communicated by the PUSCH.

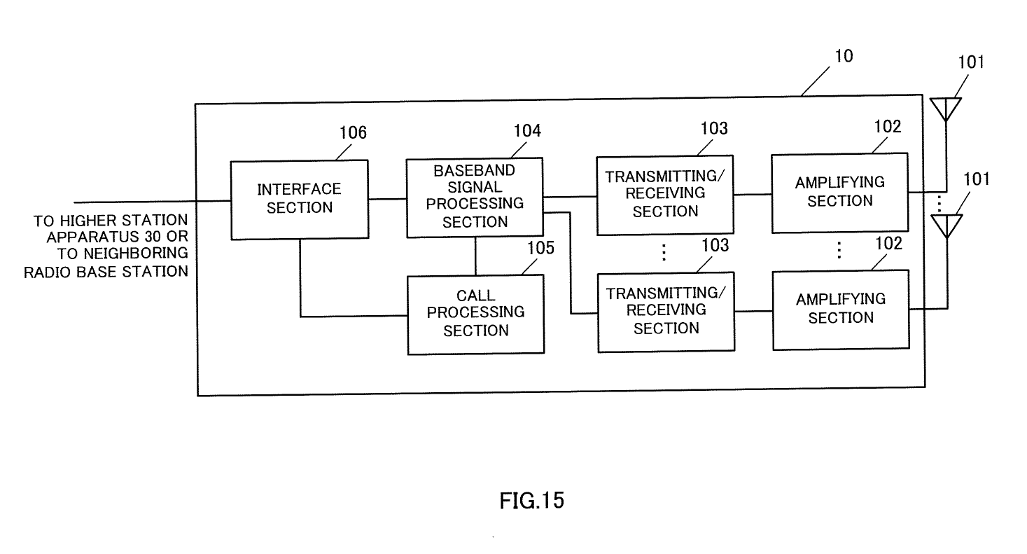

FIG. 15 is a diagram to show an overall structure of a radio base station 10 according to the present embodiment. As shown in FIG. 15, the radio base station 10 has a plurality of transmitting/receiving antennas 101 for MIMO communication, amplifying sections 102, transmitting/receiving sections (transmitting section and receiving section) 103, a baseband signal processing section 104, a call processing section 105 and an interface section 106.

User data to be transmitted from the radio base station 10 to a user terminal 20 on the downlink is input from the higher station apparatus 30, into the baseband signal processing section 104, via the interface section 106.

In the baseband signal processing section 104, a PDCP layer process, division and coupling of user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts the downlink signals, pre-coded and output from the baseband signal processing section 104 on a per antenna basis, into a radio frequency band. The amplifying sections 102 amplify the radio frequency signals having been subjected to frequency conversion, and transmit the signals through the transmitting/receiving antennas 101. For the transmitting/receiving sections 103, transmitters/receivers, transmitting/receiving circuits or transmitting/receiving devices that can be described based on common understanding of the technical field to which the present invention pertains can be employed.

On the other hand, as for uplink signals, radio frequency signals that are received in the transmitting/receiving antennas 101 are each amplified in the amplifying sections 102, converted into baseband signals through frequency conversion in each transmitting/receiving section 103, and input into the baseband signal processing section 104.

The transmitting/receiving sections 103 transmit, to the user terminals, the guaranteed transmission power value P_{xeNB} of every cell belonging to the subject cell group or the guaranteed transmission power value P_{xeNB} of every cell or every combination of multiple cells, and active/deactive information of the cells in the subject cell group. Each transmitting/receiving section 103 receives the power headroom from the user terminals.

In the baseband signal processing section 104, the user data that is included in the input uplink signals is subjected to an FFT process, an IDFT process, error correction decoding, a MAC retransmission control receiving process and RLC layer and PDCP layer receiving processes, and the result is forwarded to the higher station apparatus 30 via the interface section 106. The call processing section 105 performs call processing such as setting up and releasing communication channels, manages the state of the radio base station 10 and manages the radio resources.

The interface section 106 transmits and receives signals to and from neighboring radio base stations (backhaul signaling) via an inter-base station interface (for example, optical fiber, the X2 interface, etc.). Alternatively, the interface section 106 transmits and receives signals to and from the higher station apparatus 30 via a predetermined interface.

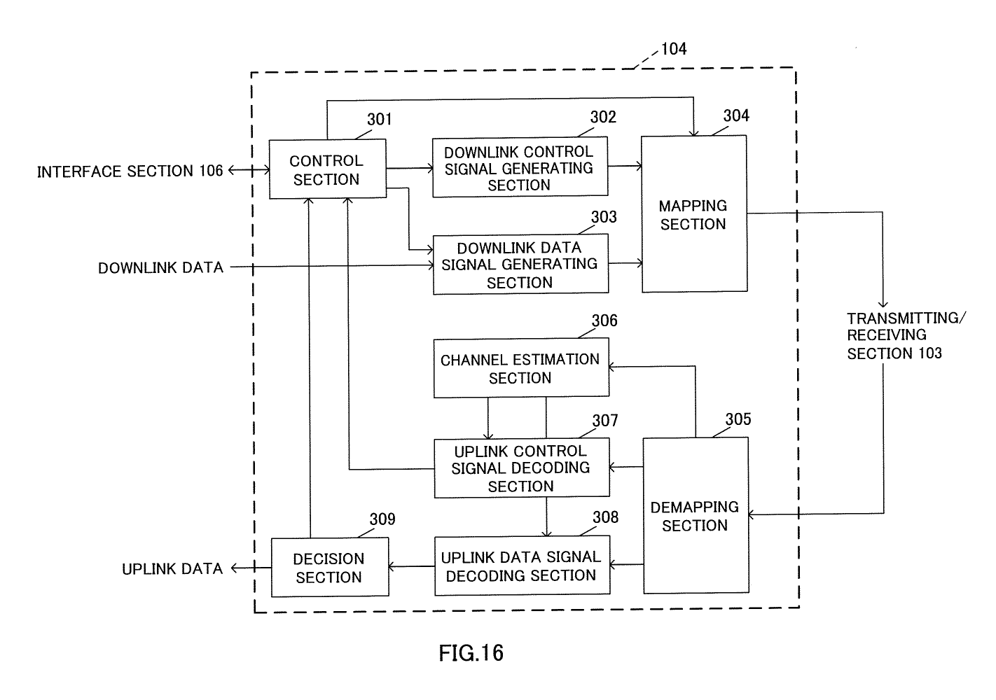

FIG. 16 is a diagram to show a principle functional structure of the baseband signal processing section 104 provided in the radio base station 10 according to the present embodiment. As shown in FIG. 16, the baseband signal processing section 104 provided in the radio base station 10 is comprised at least of a control section 301, a downlink control signal generating section 302, a downlink data signal generating section 303, a mapping section 304, a demapping section 305, a channel estimation section 306, an uplink control signal decoding section 307, an uplink data signal decoding section 308 and a decision section 309.

The control section 301 controls the scheduling of downlink user data that is transmitted in the PDSCH, downlink control information that is communicated in one or both of the PDCCH and the enhanced PDCCH (EPDCCH), downlink reference signals and so on. Also, the control section 301 controls the scheduling of RA preambles communicated in the PRACH, uplink data that is communicated in the PUSCH, uplink control information that is communicated in the PUCCH or the PUSCH, and uplink reference signals (allocation control). Information about the allocation control of uplink signals (uplink control signals, uplink user data, etc.) is reported to the user terminals 20 by using a downlink control signal (DC).

The control section 301 controls the allocation of radio resources to downlink signals and uplink signals based on command information from the higher station apparatus 30, feedback information from each user terminal 20 and so on. That is, the control section 301 functions as a scheduler. For the control section 301, a controller, a control circuit or a control device that can be described based on common understanding of the technical field to which the present invention pertains can be employed.

The downlink control signal generating section 302 generates downlink control signals (which may be both PDCCH signals and EPDCCH signals, or may be one of these) that are determined to be allocated by the control section 301. To be more specific, the downlink control signal generating section 302 generates a downlink assignment, which reports downlink signal allocation information, and an uplink grant, which reports uplink signal allocation information, based on commands from the control section 301. For the downlink control signal generating section 302, a signal generator or a signal generating circuit that can be described based on common understanding of the technical field to which the present invention pertains can be employed.

The downlink data signal generating section 303 generates downlink data signals (PDSCH signals) that are determined to be allocated to resources by the control section 301. The data signals that are generated in the data signal generating section 303 are subjected to a coding process and a modulation process, based on coding rates and modulation schemes that are determined based on CSI from each user terminal 20 and so on.

The mapping section 304 controls the allocation of the downlink control signals generated in the downlink control signal generating section 302 and the downlink data signals generated in the downlink data signal generating section 303 to radio resources based on commands from the control section 301. For the mapping section 304, a mapping circuit or a mapper that can be described based on common understanding of the technical field to which the present invention pertains can be employed.

The demapping section 305 demaps the uplink signals transmitted from the user terminals 20 and separates the uplink signals. The channel estimation section 306 estimates channel states from the reference signals included in the received signals separated in the demapping section 305, and outputs the estimated channel states to the uplink control signal decoding section 307 and the uplink data signal decoding section 308.

The uplink control signal decoding section 307 decodes the feedback signals (delivery acknowledgement signals and/or the like) transmitted from the user terminals in the uplink control channel (PRACH, PUCCH, etc.), and outputs the results to the control section 301. The uplink data signal decoding section 308 decodes the uplink data signals transmitted from the user terminals through an uplink shared channel (PUSCH), and outputs the results to the decision section 309. The decision section 309 makes retransmission control decisions (A/N decisions) based on the decoding results in the uplink data signal decoding section 308, and outputs results to the control section 301.

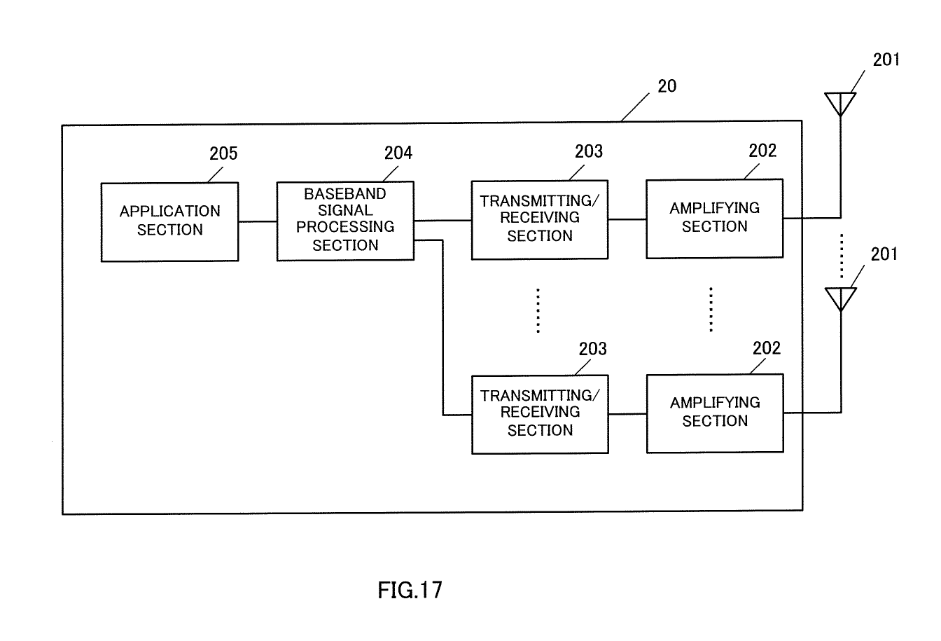

FIG. 17 is a diagram to show an overall structure of a user terminal 20 according to the present embodiment. As shown in FIG. 17, the user terminal 20 has a plurality of transmitting/receiving antennas 201 for MIMO communication, amplifying sections 202, transmitting/receiving sections (transmitting section and receiving section) 203, a baseband signal processing section 204 and an application section 205.

As for downlink data, radio frequency signals that are received in the plurality of transmitting/receiving antennas 201 are each amplified in the amplifying sections 202, and subjected to frequency conversion and converted into the baseband signal in the transmitting/receiving sections 203. This baseband signal is subjected to an FFT process, error correction decoding, a retransmission control receiving process and so on in the baseband signal processing section 204. In this downlink data, downlink user data is forwarded to the application section 205. The application section 205 performs processes related to higher layers above the physical layer and the MAC layer, and so on. Furthermore, in the downlink data, broadcast information is also forwarded to the application section 205. For the transmitting/receiving sections 203, transmitters/receivers, transmitting/receiving circuits or transmitting/receiving devices that can be described based on common understanding of the technical field to which the present invention pertains can be employed.

Meanwhile, uplink user data is input from the application section 205 to the baseband signal processing section 204. In the baseband signal processing section 204, a retransmission control (HARQ: Hybrid ARQ) transmission process, channel coding, precoding, a DFT process, an IFFT process and so on are performed, and the result is forwarded to each transmitting/receiving section 203. The baseband signal that is output from the baseband signal processing section 204 is converted into a radio frequency band in the transmitting/receiving sections 203. After that, the amplifying sections 202 amplify the radio frequency signal having been subjected to frequency conversion, and transmit the resulting signal from the transmitting/receiving antennas 201.

The transmitting/receiving sections 203 receive the value of the guaranteed transmission power P_{xeNB} of each CC or the value of the guaranteed transmission power P_{xeNB} of each combination of cells, indicated from the radio base station 10 through higher layer signaling such as RRC signaling. The transmitting/receiving section 203 receives information regarding the configuration/removal of CCs, indicated from the radio base station 10 through higher layer signaling such as RRC signaling. The transmitting/receiving section 203 receives information about the activation/deactivation of CCs, indicated from the radio base station 10 through MAC signaling.

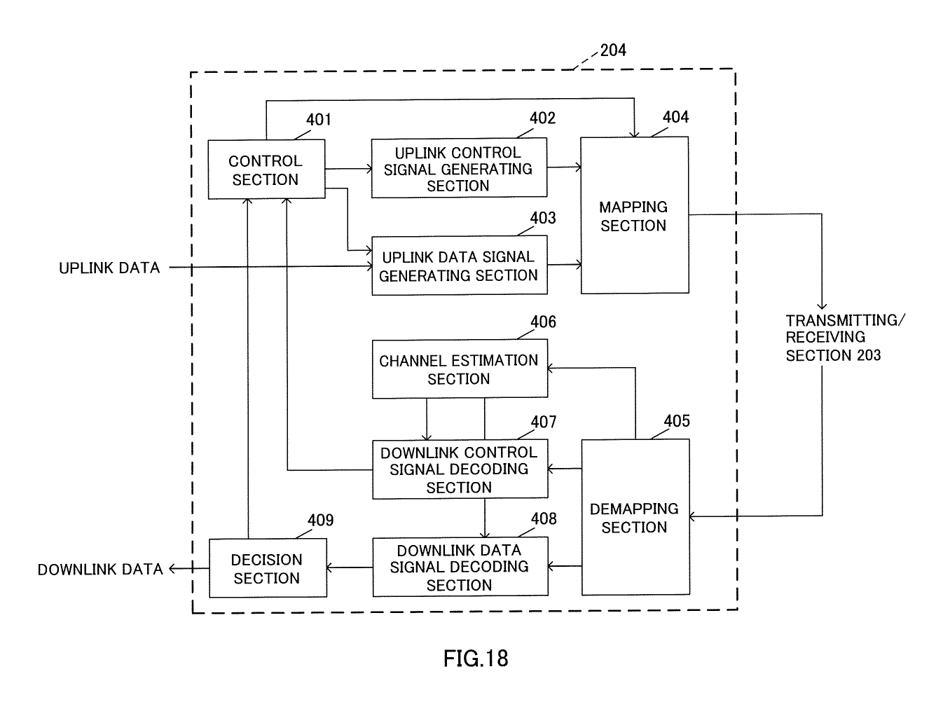

FIG. 18 is a diagram to show a principle functional structure of the baseband signal processing section 204 provided in the user terminals 20. As shown in FIG. 18, the baseband signal processing section 204 provided in the user terminal 20 is comprised at least of a control section 401, an uplink control signal generating section 402, an uplink data signal generating section 403, a mapping section 404, a demapping section 405, a channel estimation section 406, a downlink control signal decoding section 407, a downlink data signal decoding section 408 and a decision section 409.

The control section 401 controls the generation of uplink control signals (A/N signals, etc.), uplink data signals and so on, based on the downlink control signals (PDCCH signals) transmitted from the radio base stations 10, retransmission control decisions in response to the PDSCH signals received, and so on. The downlink control signals received from the radio base stations are output from the downlink control signal decoding section 408, and the retransmission control decisions are output from the decision section 409. For the control section 401, a controller or a control device that can be described based on common understanding of the technical field to which the present invention pertains can be employed.

The control section 401 functions as a power control section that controls the cell groups' guaranteed transmission power values P_{xeNB} by using the number of cells in the active state, the guaranteed transmission power value P_{xeNB,c} of every cell or P_{xeNB,c} of every combination of cells.

The uplink control signal generating section 402 generates uplink control signals (feedback signals such as delivery acknowledgement signals, channel state information (CSI) and so on) based on commands from the control section 401. The uplink data signal generating section 403 generates uplink data signals based on commands from the control section 401. Note that, when an uplink grant is contained in a downlink control signal reported from the radio base station, the control section 401 commands the uplink data signal 403 to generate an uplink data signal. For the uplink control signal generating section 402, a signal generator or a signal generating circuit that can be described based on common understanding of the technical field to which the present invention pertains can be employed.

The mapping section 404 controls the allocation of the uplink control signals (delivery acknowledgment signals and so on) and the uplink data signals to radio resources (PUCCH, PUSCH, etc.) based on commands from the control section 401.

The demapping section 405 demaps the downlink signals transmitted from the radio base station 10 and separates the downlink signals. The channel estimation section 406 estimates channel states from the reference signals included in the received signals separated in the demapping section 405, and outputs the estimated channel states to the downlink control signal decoding section 407 and the downlink data signal decoding section 408.

The downlink control signal decoding section 407 decodes the downlink control signal (PDCCH signal) transmitted in the downlink control channel (PDCCH), and outputs the scheduling information (information regarding the allocation to uplink resources) to the control section 401. Also, when information related to the cell to feed back delivery acknowledgement signals or information as to whether or not to apply RF tuning is included in a downlink control signal, these pieces of information are also output to the control section 401.

The downlink data signal decoding section 408 decodes the downlink data signals transmitted in the downlink shared channel (PDSCH), and outputs the results to the decision section 409. The decision section 409 makes retransmission control decisions (A/N decisions) based on the decoding results in the downlink data signal decoding section 408, and outputs the results to the control section 401.

Note that the present invention is by no means limited to the above embodiment and can be carried out with various changes. The sizes and shapes illustrated in the accompanying drawings in relationship to the above embodiment are by no means limiting, and may be changed as appropriate within the scope of optimizing the effects of the present invention. Besides, implementations with various appropriate changes may be possible without departing from the scope of the object of the present invention.

The disclosure of Japanese Patent Application No. 2014-134751, filed on Jun. 30, 2014, including the specification, drawings and abstract, is incorporated herein by reference in its entirety.

1. A user terminal that communicates with a plurality of cell groups, each cell group being comprised of one or more cells that use different frequencies, the user terminal comprising:
a receiving section that receives a guaranteed transmission power value of each cell and active/non-active information of the cells in the cell groups; and
a power control section that controls guaranteed transmission power values of the cell groups by using a number of cells in an active state and the guaranteed transmission power value of each cell.

2. A user terminal that communicates with a plurality of cell groups, each cell group being comprised of one or more cells that use different frequencies, the user terminal comprising:
a receiving section that receives a guaranteed transmission power value of each cell and each combination of multiple cells and active/non-active information of the cells in the cell groups; and
a power control section that controls guaranteed transmission power values of the cell groups by using a number of cells in an active state and the guaranteed transmission power value of each cell and each combination of multiple cells.

3. The user terminal according to claim 1, wherein the guaranteed transmission power values of the cell groups are controlled based on proportions with respect to maximum possible transmission power of the subject terminal.

4. The user terminal according to claim 1, further comprising a transmission section that, when non-active information of a cell is received, transmits power headroom to a plurality of radio base stations forming the cell groups.

5. The user terminal according to claim 1, wherein, when the cells are divided into subframe sets, the power control section controls the guaranteed transmission power values on a per subframe set basis.

6. The user terminal according to claim 1, wherein the guaranteed transmission power value of each cell is configured by higher layer signaling.

7. A radio base station that foil is a cell group comprised of one or more cells to use different frequencies, and that communicates with a user terminal by employing dual connectivity with another radio base station forming a different cell group from the cell group, the radio base station comprising:
a transmission section that transmits, to the user terminal, a guaranteed transmission power value of each cell belonging to a subject cell group or a guaranteed transmission power of each cell and each combination of multiple cells, and active/non-active information of the cells in the subject cell group.

8. A radio communication system, in which cell groups that are each comprised of one or more cells to use different frequencies are formed, and in which a radio base station communicates with a user terminal by employing dual connectivity with another radio base station forming a different cell group from the cell group, wherein:
the radio base station comprises:
a transmission section that transmits, to the user terminal, a guaranteed transmission power value of each cell belonging to a subject cell group and active/non-active information of the cells in the subject cell group; and
the user terminal comprises:
a receiving section that receives the guaranteed transmission power value of each cell and the active/non-active information of the cells in the cell groups; and
a power control section that controls guaranteed transmission power values of the cell groups by using a number of cells in an active state and the guaranteed transmission power value of each cell.

9. A radio communication method in a user terminal that communicates with a plurality of cell groups, each cell group being comprised of one or more cells that use different frequencies, the radio communication method comprising the steps of:
receiving a guaranteed transmission power value of each cell and active/non-active information of the cells in the cell groups; and
controlling guaranteed transmission power values of the cell groups by using a number of cells in an active state and the guaranteed transmission power value of each cell.

10. The user terminal according to claim 2, wherein the guaranteed transmission power values of the cell groups are controlled based on proportions with respect to maximum possible transmission power of the subject terminal.

11. The user terminal according to claim 2, further comprising a transmission section that, when non-active information of a cell is received, transmits power headroom to a plurality of radio base stations forming the cell groups.

12. The user terminal according to claim 2, wherein, when the cells are divided into subframe sets, the power control section controls the guaranteed transmission power values on a per subframe set basis.
